(19) United States
(12) Patent Application Publication
(10) Pub. No.: US 2026/0160974 A1
(43) Pub. Date: Jun. 11, 2026

(54) OPTICAL DEVICE AND IMAGING APPARATUS

(71) Applicant: CANON KABUSHIKI KAISHA, Tokyo (JP)

(72) Inventor: KATSUHIRO INOUE, Tochigi (JP)

(21) Appl. No.: 19/179,184

(22) Filed: Apr. 15, 2025

(30) Foreign Application Priority Data
Apr. 22, 2024 (JP) 2024-068750

(51) Int. Cl. G02B 7/16

(52) U.S. Cl. CPC G02B 7/16

(57) ABSTRACT

An optical device includes a movable member that holds an optical element and is rotatable about a first rotation axis parallel to an optical axis, and a transmission mechanism that transmits a force from an operation portion to the movable member. The movable member is switchable between an inserted state in which the optical element is inserted onto the optical axis and a retracted state in which the optical element is retracted from the optical axis according to an operation of the operation portion, and the transmission mechanism and the first rotation axis do not overlap with each other when switching between the inserted state and the retracted state when viewed from the optical axis direction.

### BACKGROUND OF THE INVENTION

### Field of the Invention

The present disclosure relates to an optical device and an imaging apparatus.

### Description of the Related Art

Conventionally, as a lens device (optical device) used in an imaging apparatus, a device including a lens (extender) that can be inserted into and removed from an optical path is known.

PCT International Publication No. WO2019/131186 discloses a lens device provided with an operation portion for a photographer to perform an insertion and removal operation of an extender.

### SUMMARY

An optical device according to an aspect of the present disclosure comprising: a movable member configured to hold an optical element and be rotatable about a first rotation axis parallel to an optical axis; and a transmission mechanism configured to transmit a force from an operation portion to the movable member, wherein the movable member is switchable between an inserted state in which the optical element is inserted onto an optical axis and a retracted state in which the optical element is retracted from the optical axis according to an operation of the operation portion, and wherein when viewed from the optical axis direction, the transmission mechanism and the first rotation axis do not overlap with each other when switching between the inserted state and the retracted state.

Further features of the disclosure will become apparent from the following description of exemplary embodiments with reference to the attached drawings.

### BRIEF DESCRIPTION OF THE DRAWINGS

FIG. 1 is a perspective view illustrating characteristic portions of a lens barrel according to the embodiment.

FIG. 2 is a schematic cross-sectional view of the lens barrel according to the embodiment.

FIG. 3 is a cross-sectional view of a first rotation axis portion according to the embodiment.

FIG. 4 is a cross-sectional view of a fourth group barrel located at the insertion position according to the embodiment, as viewed from the imaging surface side along the optical axis.

FIG. 5 is a cross-sectional view of the fourth lens group barrel in the retracted position according to the embodiment, as viewed from the imaging surface side along the optical axis.

FIG. 6 is a cross-sectional view of the second rotation axis portion of the operation member according to the embodiment.

FIG. 7 is a cross-sectional view of the third rotation axis portion in the first connecting portion according to the embodiment.

FIG. 8 is a cross-sectional view of the second extending portion of the intermediate member extending in the optical axis direction in the second connecting portion according to the embodiment.

FIG. 9 is a side view of the lens barrel as viewed from the operation portion side according to the embodiment.

FIG. 10 is a view illustrating characteristic portions of the lens barrel according to the embodiment, from the same viewpoint as FIG. 9.

### DESCRIPTION OF THE EMBODIMENTS

Hereinafter, a preferred embodiment of the present disclosure will be explained below using embodiments and figures, with reference to the accompanying drawings. Note that, in each drawing, the same reference numbers are assigned to the same components or elements, and redundant explanations will be omitted or simplified.

### First embodiment

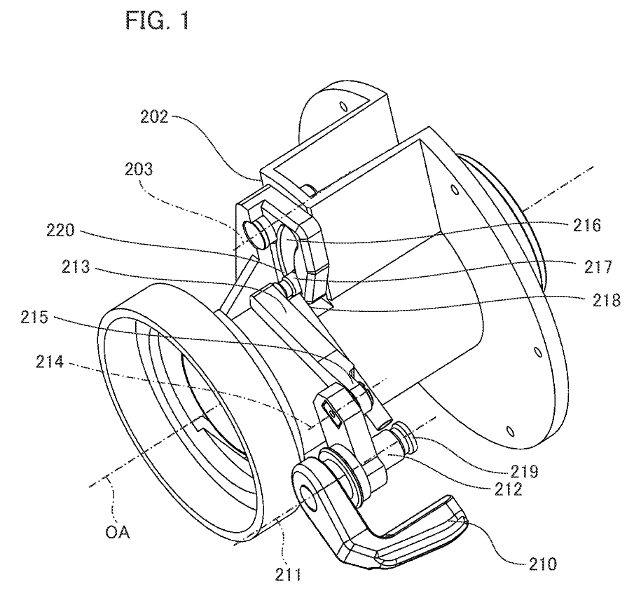

Hereinafter, a lens barrel (optical device) 1 of the present embodiment and its characteristic portions will be explained with reference to FIG. 1 to FIG. 10. The lens barrel 1 includes a mechanism capable of inserting and removing a fourth group barrel 202 into and from an insertion position where the magnifying optical system (lens, optical element) 201 held by the fourth group barrel 202, preferably the central axis thereof, is located on the optical axis, and a retraction position where the magnifying optical system 201, preferably the central axis thereof, is retracted from the optical axis, according to an operation of an operation portion 210. There is an extender as a means of changing a focal length to a focal length at which a more telephoto image can be captured according to an image capturing scene. The extender is used by being mounted between a camera body and a master lens, and the focal length is extended to, for example, 1.4 times or 2.0 times. However, there is a concern that an extender that is attached to and detached from the master lens requires time and effort to attach and detach the extender, and dust may enter the extender when the extender is being attached and detached. Accordingly, there is a lens barrel in which an extender is built in the lens barrel to prevent the trouble of attachment and detachment and the possibility of dust entering the extender at the time of attachment and detachment. In a case in which the extender is built in such a lens barrel, a photographer needs to perform an insertion and removal operation for moving the extender between a position where the central axis of the magnifying optical system of the extender is on the optical axis and a position where the central axis of the magnifying optical system of the extender is retracted from the optical axis. In consideration of convenience at the time of image capturing, it is desired that the operation of inserting and removing the extender by the photographer is easier and more comfortable.

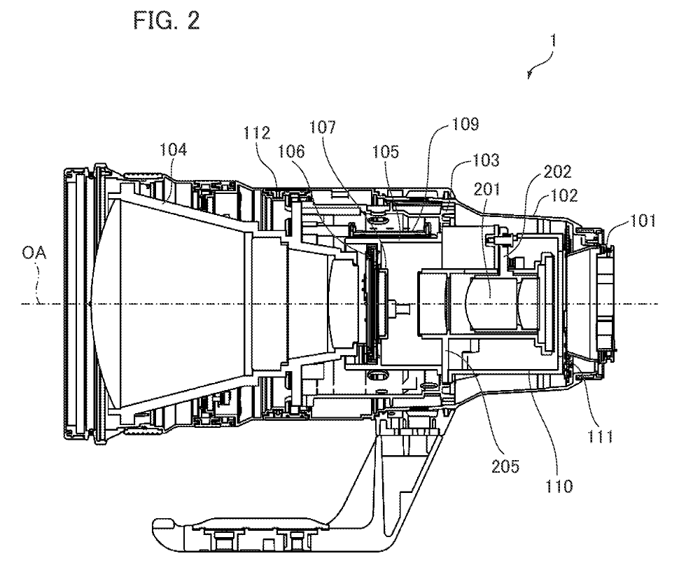

FIG. 1 is a perspective view illustrating characteristic portions of the lens barrel 1 according to the present embodiment. Specifically, FIG. 1 is a perspective view illustrating a mechanism of inserting and removing an extender in a state in which the fourth group barrel 202 that holds the magnifying optical system 201 is at an insertion position where the central axis of the magnifying optical system 201 is located on the optical axis OA of the lens barrel 1. FIG. 2 is a schematic cross-sectional view of the lens barrel 1 according to the present embodiment.

A mount 101 is a component that is fixed to a camera body (not illustrated) in which an imaging element and other components that capture images of a subject through the magnifying optical system 201 (lens) are arranged. That is, the mount 101 in the lens barrel 1 is configured to be attachable to a mount provided in the camera body, and can be communicably connected to the camera body by being attached to the mount provided in the camera body. Furthermore, an imaging apparatus can be configured by the lens barrel 1 and a camera body having an imaging element. The imaging apparatus is configured to be capable of capturing an image formed through the lens barrel 1. Note that the imaging apparatus may be an imaging apparatus in which the lens barrel 1 and the camera body are integrated.

An outer cylinder 102 is diametrically fitted to the mount 101, which is attachable to and detachable from the camera body, and abutted in the optical axis OA direction (the direction along the optical axis), thereby restricting the optical axis OA direction. The mount 101 and the outer cylinder 102 are fastened together with tightening members such as screws. The outer cylinder 102 is diametrically fitted to a first fixed cylinder 103 and abutted in the optical axis OA direction to restrict the optical axis OA direction, and fastened with screws in the optical axis OA direction.

The first fixed cylinder 103 is diametrically fitted to a first group barrel 104, which holds a lens, abutted in the optical axis OA direction to restrict the optical axis OA direction, and fastened with tightening members such as screws in the optical axis OA direction. Additionally, a third lens barrel 205 is assembled from the imaging surface side and diametrically fitted to the first fixed cylinder 103, abutted in the optical axis OA direction to restrict the optical axis OA direction, and fastened with tightening members such as screws in the optical axis OA direction. A second fixing member 105 is assembled from the object side and diametrically fitted to the third lens barrel 205, abutted in the optical axis OA direction to restrict the optical axis OA direction, and fastened with tightening members such as screws in the optical axis OA direction.

A light amount adjusting member 106 that adjusts the light amount of the lens barrel (optical apparatus) 1 is fixed to the second fixing member 105. A second group barrel 107, which is a focus group, is provided on the inner side (inner diameter side) of the second fixing member 105 in the radial direction, and the second group lens barrel 107 engages with a linearly moving guide bar (not illustrated) and is guided by the linearly moving guide bar in the optical axis OA direction (moves in the direction along the optical axis). An actuator 109 is a drive source that extendably and retractably moves the second group barrel 107 in the optical axis OA direction, and functions as a drive unit.

A driving force is transmitted to the second group barrel 107 via a rack (not illustrated) that engages with a drive unit of the actuator 109, and the second group barrel 107 can be reciprocally moved (can move) in the optical axis OA direction. The rack (not illustrated) is rotatably held about an axis (not illustrated) extending in the optical axis OA direction, with respect to the second group barrel 107. The rack (not illustrated) is biased in the rotation direction by a biasing force in the torsion direction generated by a torsion coil spring (not illustrated) and is pressed against the second group barrel 107 from one direction of the radial direction. The rack (not illustrated), the second group barrel 107, and the actuator 109 are pressed against each other by these biasing forces, thereby preventing rattling therebetween.

The position of a relay barrel 110 in a plane orthogonal to the optical axis is determined by two bosses (not illustrated), which are protrusions for position adjustment that protrude in the optical axis OA direction of the first fixed cylinder 103 and are arranged at different angular positions about the optical axis, and two engagement holes (not illustrated) on the relay barrel 110 side that engage with the bosses. Additionally, the movement of the relay barrel 110 in the optical axis OA direction is restricted by being abutted in the optical axis OA direction, and the rely barrel 110 is fastened in the optical axis OA direction with tightening members such as screws. A control substrate 111 is also fastened to the relay barrel 110 in the optical axis OA direction with tightening members such as screws . The fourth group barrel (movable member) 202 holding the magnifying optical system 201 is held so as to be rotatable about a first rotation axis 203 that is parallel to the optical axis OA for rotating between an insertion position and a retracted position with respect to the third group barrel 205. Note that the retracted position refers to a position where the central axis of the magnifying optical system 201 held by the fourth group barrel 202 is moved away from the optical axis OA.

A detailed configuration around the fourth group barrel 202 will be described below. A detection member (not illustrated) detects the rotation amount and rotation direction of a focus ring 112, which is one of the components that configures the exterior unit. A predetermined drive signal from the control circuit on the control substrate 111 is sent to the actuator 109 based on the output of the detection member (not illustrated), and the second group lens barrel 107 is driven in the optical axis direction.

The fourth group barrel 202 includes a first rotating axis 203 and rotates (turns) about the first rotation axis 203 (about the rotation axis), as described above. Additionally, the lens barrel 1 is integrally connected to the operation portion 210 that is located on the outer side (outer diameter side) of the lens barrel 1 in the radial direction and is operated by a photographer. The fourth group barrel 202 can be switched between an insertion position state in which the magnifying optical system 201 is inserted onto the optical axis and a retracted position state in which the magnifying optical system is retracted from the optical axis according to the operation of the operation portion 210. As a result, the photographer can insert and remove the extender using just their right hand while supporting the lens barrel with their left hand. Therefore, it is possible to change the focal length according to the image capturing scene while concentrating on the image capturing. The fourth group barrel 202 further includes an operation member (rotating member) 212 that rotates (is rotatable) about a second rotation axis 211 parallel to the optical axis OA according to an operation of the operation portion 210.

An intermediate member 213 includes a first connecting portion 215 and a second connecting portion 217. The first connection portion 215 is connected to the operation member 212 so as to be relatively rotatable about a third rotation axis 214 that is parallel to the optical axis OA. The second connecting portion 217 engages with a guide portion 216 provided on the fourth group barrel 202. The second connecting portion 217 is a member that transmits a driving force to rotate the fourth group barrel 202 about the first rotation axis 203 from the insertion position to the retracted position or in the opposite direction. That is, the second connecting portion 217 engages with the guide portion 216 that is provided in the fourth group barrel 202, thereby transmitting the force from the operation portion 210 to the fourth group barrel 202. Additionally, the second connecting portion 217 engages with the guide portion 216 that is provided on a plane (in the plane) orthogonal to the optical axis OA in the fourth group barrel 202 and thus can move inside the guide portion 216 between the insertion position and the retracted position. In other words, the second connecting portion 217 can move inside the guide portion 216 when switching between the inserted state (first state) and the retracted state (second state).

A first biasing member 218 has one end that engages with a first engaging portion 219 in the vicinity of the shaft portion of the second rotation axis 211, and the other end of the first biasing member 218 engages with a second engaging portion 220 in the vicinity of the second connecting portion 217. The first biasing member 218 attracts the first engaging portion 219 and the second engaging portion 220 to each other by its biasing force. That is, the first biasing member 218 can apply a biasing force for holding the fourth group barrel 202 to the fourth group barrel 202 at the insertion position and the retracted position. In other words, the first biasing member 218 holds the fourth group barrel 202 by biasing the fourth group barrel 202 in the inserted state and the retracted state. The first biasing member 218 is a tension coil spring (elastic member) having hook portions (not illustrated) at both ends. Note that these configurations will be explained in detail below.

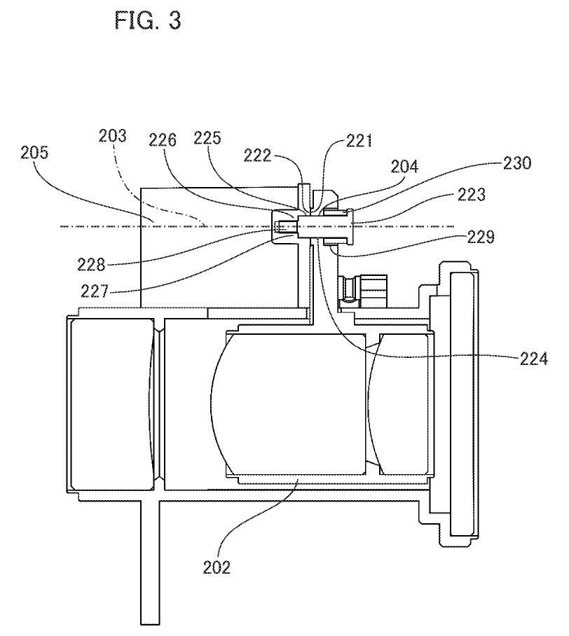

FIG. 3 is a cross-sectional view of the first rotation axis 203 of the fourth group barrel 202 according to the present embodiment. A first contact surface 221 of the fourth group barrel 202 having the first rotation axis 203 is a surface that is brought into contact with the third group barrel 205 in the optical axis OA direction, and specifically, it is brought into contact with a second contact surface 222 that is a surface of the third group barrel 205 on the fourth group barrel 202 side in the optical axis OA direction. The fourth group barrel 202 has a first fitting portion 204 that is coaxial with the first rotation axis 203. A first fastening member 223 has a second fitting portion 224. The first fitting portion 204 of the fourth group barrel 202 is fitted to the second fitting portion 224 of the first fastening member 223. The third lens barrel 205 has a third fitting portion 225. The second fitting portion 224 is also fitted to the third fitting portion 225. Thus, the second fitting portion 224 is fitted to both the first fitting portion 204 and the third fitting portion 225.

A third contact surface 226 of the first fastening member 223 is a surface that is brought into contact with the third group barrel 205 in the optical axis OA direction, and is brought into contact with a fourth contact surface 227 that is a surface of the third group barrel 205 on the first fastening member 223 side in the optical axis OA direction. Accordingly, the movement of the fourth group barrel 202 is restricted in the optical axis OA direction. Then, the first fastening member 223 is fastened to the third lens barrel 205 with the first screw portion 228.

A second biasing member 230 is interposed between the bottom surface of the counterbored hole portion 229 of the fourth group barrel 202 and the first fastening member 223, and the fourth group barrel 202 is biased toward the third group barrel 205 by the biasing force of the second biasing member 230, so that the movement is restricted in the optical axis OA direction. Accordingly, the fourth group barrel 202 is pivotable (rotatable) about the first rotation axis 203 while being restricted from moving in the optical axis OA direction. Note that any means may be used as the means of rotation.

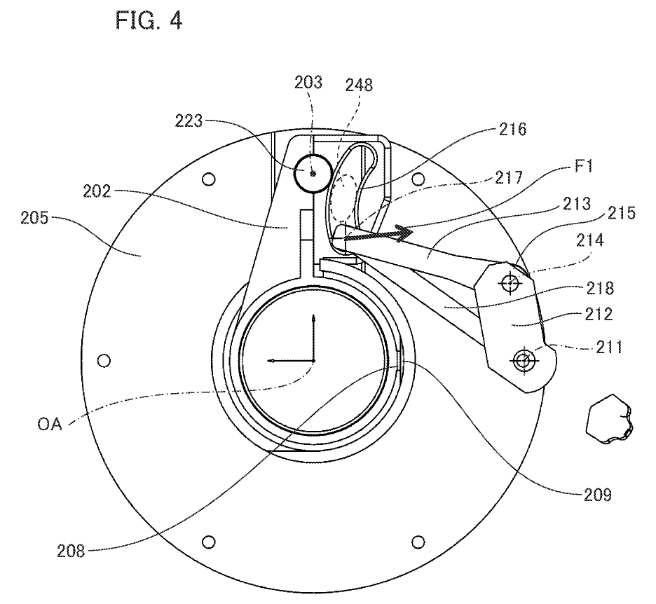

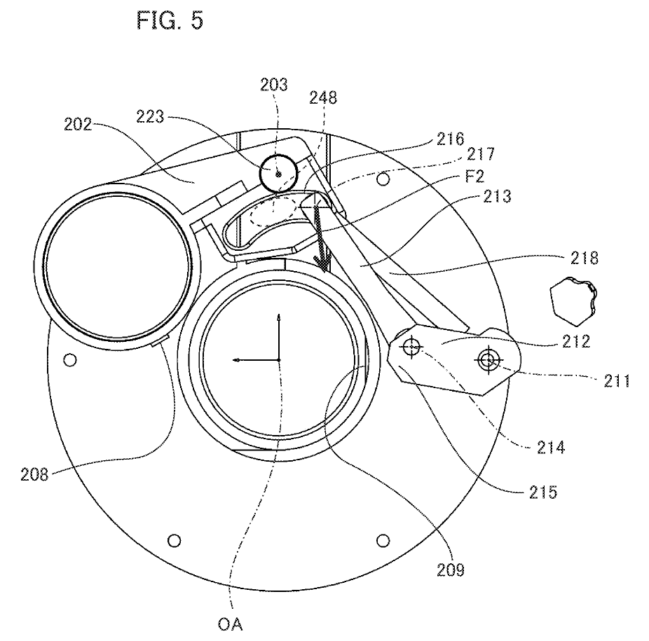

FIG. 4 is a cross-sectional view of a state in which the central axis of the magnifying optical system 201 that is held by the fourth group barrel 202 according to the present embodiment is at the insertion position located on the optical axis OA, as viewed from the imaging plane side on the optical axis OA. FIG. 5 is a cross-sectional view of a state in which the fourth group barrel 202 according to the present embodiment is at the retracted position, as viewed from the imaging plane side on the optical axis OA.

The first restriction portion 208 restricts the rotation of the fourth group barrel 202 in the inserted state. Specifically, as shown in FIG. 4, when the fourth group barrel 202 moves from the retracted position to the insertion position, rotation about the first rotation axis 203 is restricted by a first restriction portion 208 of the fourth group barrel 202 being brought into contact with a second restriction portion 209 on the side of a third group barrel 205. That is, the second restricting portion 209 restricts the rotation of the first restricting portion 208. Even when the fourth group barrel 202 rotates about the first rotation axis 203, the first restriction portion 208 provided in the fourth group barrel 202 is brought into contact with the second restriction portion 209 provided in the third group barrel, making it such that the rotation about the first rotation axis 203 is restricted.

Further, as shown in FIG. 5, the fourth group barrel 202 rotates about the first rotation axis 203 in a direction away from the operation portion 210 in a region opposite to the region where the operation portion 210 is disposed, thereby being located at the retracted position. Thus, even when the fourth group barrel 202 overlaps with the operation portion 210 in the optical axis OA direction, interference between the fourth group barrel 202 and the operation portion 210 does not occur at the retracted position. Consequently, there is no restriction on the movement of the photographer’s right hand, which is performing the operations, and comfortable operation can be realized.

Additionally, a shock-absorbing member (not illustrated) may be placed between the first restriction portion 208 and the second restriction portion 209. That is, a shock-absorbing member may be attached to the surface of the first restriction portion 208 on the side that is in contact with the second restriction portion 209, the shock-absorbing member may be attached to the surface of the second restriction portion 209 that is on the side that is in contact with the first restriction portion 208, or the shock-absorbing member may be attached to both of these. As a result, it is possible to reduce damage to both the first restriction portion 208 and the second restriction portion 209 that is caused by the application of a considerably large impact due to collisions between the first restriction portion 111 and the second restriction portion 112, and it is also possible to reduce collision noise at the time of collisions.

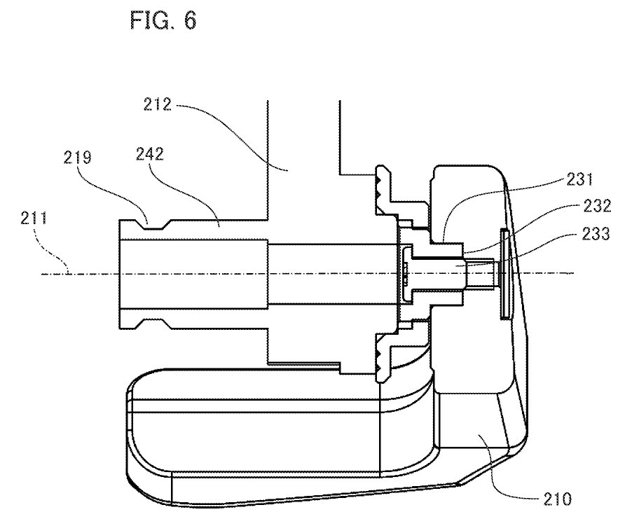

FIG. 6 is a cross-sectional view of the second rotation axis 211 of the operation member 212 according to the present embodiment. The operation member 212 has a fourth fitting portion 231. Then, the operation member 212 is fitted to the operation portion 210 via the fourth fitting portion 231. That is, the fourth fitting portion 231 is fitted to the concave portion provided in the operation portion 210. Additionally, a fifth contact surface 232 of the operation member 212 is a surface that is brought into contact with the operation portion 210 in the optical axis OA direction, and the fifth contact surface 232 of the operation member 212 is brought into contact with the surface of the operation portion 210 on the operation member 212 side.

The operation member 212 is fastened to the operation portion 210 by a second fastening member 233 while being restricted from rotating with respect to the operation portion 210. Accordingly, when the photographer (operator) operates the operation portion 210, the operation member 212 rotates about the second rotation axis 211 integrally with the operation portion 210. Additionally, the operation member 212 includes a first extending portion 242 that extends in the optical axis OA direction. The first extending portion 242 is provided with the first engaging portion 219, and as described above, the first engaging portion 219 engages with one end of the first biasing member 218.

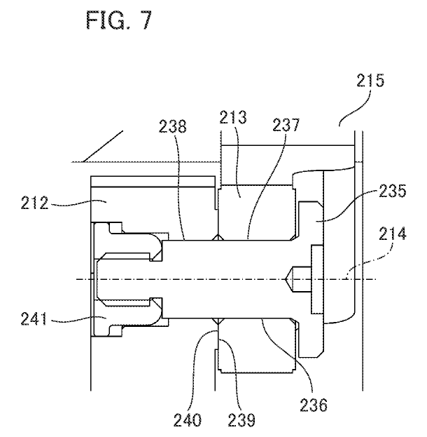

FIG. 7 is a cross-sectional view of the third rotating axis 214 in the first connecting portion 215 according to the present embodiment. The third fastening member 235 has a fifth fitting portion 236. Additionally, the intermediate member 213 has a sixth fitting portion 237. The fifth fitting portion 236 of the third fastening member 235 is fitted to the sixth fitting portion 237 of the intermediate member 213. The operation member 212 has a seventh fitting portion 238. The fifth fitting portion 236 of the third fastening member 235 is fitted to the seventh fitting portion 238 of the operation member 212.

A sixth contact surface 239 of the intermediate member 213 is brought into contact with the operation member 212 in the direction of the optical axis OA, and is brought into contact with a seventh contact surface 240 of the operation member 212 on the side of the operation member 212. Thus, the intermediate member 213 and the operation member 212 are in contact with each other via the above-described surfaces. In the first connecting portion 215, the intermediate member 213 and the operation member 212 are interposed between the third fastening member 235 and the nut member 241, and are relatively rotatable about the third rotating axis 214.

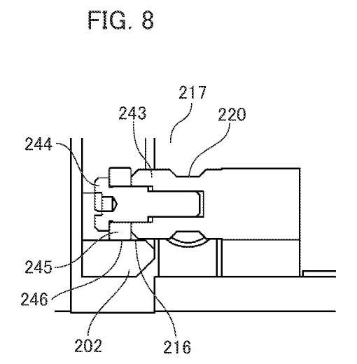

FIG. 8 is a cross-sectional view of a second extending portion 243 extending in the optical axis OA direction of the intermediate member 213 in the second connecting portion 217 according to the present embodiment. A fourth fastening member 244 is fastened (attached, provided) to the second engaging portion 220 through a bearing (moving member) 245. As shown in FIG. 8, the bearing 245 is interposed between the second extending portion 243 and the fourth fastening member 244. An outer diameter portion 246 of the bearing 245 is brought into contact with the guide portion 216 provided in the fourth group barrel 202.

As shown in FIG. 4, when the fourth group barrel 202 is in a state of being in the insertion position, the first biasing member 218 exerts an attracting force between the first engaging portion 219, with which one end of the first biasing member 220 is engaged, and the second engaging portion 220 with which the other end of the first biasing member 218 is engaged. Therefore, a biasing force F1 is applied to the guide portion 216 of the fourth group barrel 202 from the bearing 245 that is attached to the intermediate member 213. When the biasing force F1 is applied to the fourth group barrel 202, a moment acts on the fourth group barrel 202 in the counterclockwise direction about the first rotation axis 203 in FIG. 4. As a result, when the fourth group barrel 202 is in a state of being in the insertion position, the fourth group barrel 202 is always biased so as to maintain the insertion position.

When the operation portion 210 is rotated about the second rotation axis 211, the operation member 212 and the intermediate member 213 rotate relatively to each other about the third rotation axis 214 in the first connecting portion 215. As a result, the bearing 245 of the second connecting portion 217 moves inside the guide portion of the fourth group barrel 202 to be in the state of the retracted position as shown in FIG. 5. That is, the second connecting portion 217 also moves in conjunction with the moving direction of the bearing. In other words, the second connecting portion 217 moves inside the guide portion 216 in conjunction with the movement of the bearing 245.

Even in the state of the retracted position, the first biasing member 218 exerts an attracting force to attract each other between the first engaging portion 219, with which one end of the first biasing member 220 is engaged, and the second engaging portion 220 with which one end and the other end of the first biasing member 218 is engaged. Therefore, the biasing force F2 is applied to the guide portion 216 of the fourth group barrel 202 from the bearing 245 that is attached to the intermediate member 213. When the biasing force F2 is applied to the fourth group barrel 202, a moment acts on the fourth group barrel 202 in the clockwise direction about the first rotation axis 203 in FIG. 5. As a result, when the fourth group barrel 202 is in a state of being in the retracted position, the fourth group barrel 202 is always biased so as to maintain the retracted position.

Thus, the second connecting portion 217 moves in the guide portion 216 at the insertion position and the retracted position, and the direction of the moment about the first rotating shaft 203 applied to the group 4 lens barrel 202 is reversed by a change in the position with which the guide portion 216 is engaged. In other words, at the time of switching between the inserted state and the retracted state, the second connecting portion 217 moves inside the guide portion 216, so that the direction of a moment about the first rotation axis 203 applied to the fourth group barrel 202 is reversed.

In the retracted position of FIG. 5, the bearing 245 is moved to the position for the bearing 245 when it is incontact with the guide portion 216, in contrast to the position for the bearing 245 when it is in contact with the guide portion 216 of the four group lens barrel 202 in the insertion position of FIG. 4. Thus, the bearing 245 rolls (slides) into contact with the guide portion 216 from the insertion position to the retracted position or in the opposite direction, and moves in the guide portion 216.

Additionally, the guide portion 216 is formed in a non-linear shape so as to maintain the fourth group barrel 202 in the insertion position and the retracted position. Specifically, an intermediate portion region 248 in the guide portion 216 has a shape that is convex in a direction that is opposite to the direction in which the second connecting portion 217 receives a biasing force by the first biasing member 218. In other words, as shown in FIG. 4 and FIG. 5, the intermediate portion region 248 has a curved shape (curved line shape) that protrudes in a direction opposite to a direction in which the biasing force is received when viewed from the optical axis direction. The guide portion 216 includes a non-linear curved guide surface when viewed from a direction in a plane perpendicular to the optical axis. Specifically, the guide surface of the guide portion 216 with which the second connecting portion 217 is brought into contact in the state between the inserted state and the retracted state has a shape that is convex in the direction opposite to the direction in which the second connecting portion 217 is biased by the first biasing member 218 when viewed from the optical axis direction. Therefore, the bearing 245 gradually moves in the guide portion 216 from when it begins to move from the insertion position to the retracted position or in the opposite direction and the bearing 245 maintains its position at the insertion position and the retracted position. Note that the intermediate portion region 248 is a region within the guide portion 216 except for the region in which the fourth group barrel 202 is in the insertion position and the region in which the fourth group barrel 202 is in the retracted position. Specifically, the intermediate portion region 248 indicates a region within the guide portion 216 other than a state in which the bearing 245 is positioned at one end side of the guide portion 216 and a state in which the bearing 245 is positioned at the other end side of the guide portion 216.

In the conventional mechanism, during the movement of the fourth group barrel 202 from the insertion position to the retracted position, the first rotation axis 203 of the fourth group barrel 202 and the first biasing member 218 need to be arranged so as to overlap with each other when viewed from the optical axis OA direction. Therefore, a space is always required in the optical axis OA direction in order to prevent interference with the front and rear members, which can be a factor that inhibits shortening of the total length of the lens barrel 1.

In the present embodiment, the operating force transmission mechanism, in which the photographer operates the operating unit 210 and transmits the operating force from the operation portion 210 to the fourth group barrel 202 that holds the magnifying optical system 201, can be configured at a position that does not always overlap with the first rotation axis 203 of the fourth group barrel 202 when viewed from a direction along the optical axis OA direction. In other words, the operating force transmission mechanism and the first rotation axis 203 do not overlap with each other at least between the insertion position and the retracted position when viewed from the direction along the optical axis OA. In other words, when viewed from the optical axis direction, the operation force transmission mechanism and the first rotation axis 203 do not overlap with each other at the time of switching between the inserted state and the retracted state. The operating force transmission mechanism is configured by at least the operating member 212, the intermediate member 213, the first connecting portion 215, the second connecting portion 217, and the first biasing member 218.

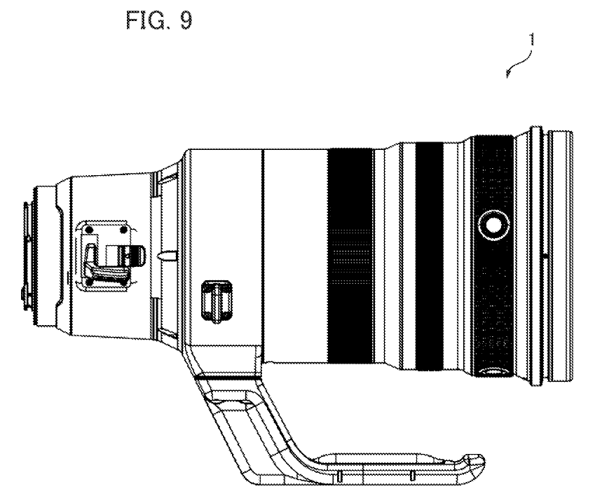

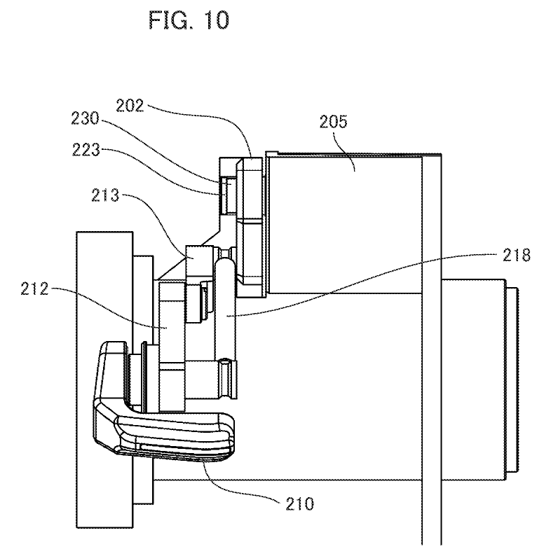

FIG. 9 is a view of the lens barrel 1 according to the present embodiment as viewed from the side of the operation portion 210 and directly from the side. FIG. 10 is a cross-sectional view illustrating characteristic portions of the lens barrel according to the embodiment, from the same viewpoint as FIG. 9. As shown in FIG. 10, in the present embodiment, the operation member 212, the intermediate member 213, and the first biasing member 218 overlap in the optical axis OA direction with the fourth group barrel 202 that rotates about the first rotation axis 203, the first fastening member 223 that supports rotation, the second biasing member 230, and the like.

As described above, according to the lens barrel 1 of the present embodiment, the insertion and removal mechanism of the extender can be configured in a space-saving manner while having a simple structure, thereby reducing the total length of the lens barrel. While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-068750, April 22, 2024, which is hereby incorporated by reference wherein in its entirety.

What is claimed is:

1. An optical device comprising:
a movable member configured to hold an optical element and be rotatable about a first rotation axis parallel to an optical axis; and
a transmission mechanism configured to transmit a force from an operation portion to the movable member,
wherein the movable member is switchable between an inserted state in which the optical element is inserted onto an optical axis and a retracted state in which the optical element is retracted from the optical axis according to an operation of the operation portion, and
wherein when viewed from the optical axis direction, the transmission mechanism and the first rotation axis do not overlap with each other when switching between the inserted state and the retracted state.

2. The optical device according to claim 1, wherein the transmission mechanism includes a biasing member for holding the movable member by biasing the movable member in the inserted state and the retracted state.

3. The optical device according to claim 1, wherein the transmission mechanism includes a rotating member that is rotatable about a second rotation axis parallel to an optical axis according to an operation of the operation portion; and a connecting portion that is connected to the rotating member so as to be relatively rotatable about a third rotation axis parallel to the optical axis.

4. The optical device according to claim 1, wherein the transmission mechanism includes a connecting portion that transmits the force to the movable member by engaging with a guide portion provided in the movable member; and the connecting portion moves inside the guide portion when switching between the inserted state and the retracted state.

5. The optical device according to claim 4, wherein when switching between the inserted state and the retracted state, the connecting portion moves inside the guide portion, so that the direction of a moment about the first rotation axis applied to the movable member is reversed.

6. The optical device according to claim 4, wherein a moving member is provided in the connecting portion, and the connecting portion moves inside the guide portion in conjunction with movement of the moving member.

7. The optical device according to claim 1 further comprising a first restriction portion configured to restrict rotation of the movable member in the inserted state.

8. The optical device according to claim 7 further comprising a second restriction portion configured to restrict rotation of the first restriction portion.

9. The optical device according to claim 2, wherein the transmission mechanism includes a rotating member that is rotatable about a second rotation axis parallel to an optical axis according to an operation of the operation portion; and one end of the biasing member engages with a first engagement portion provided in the rotating member.

10. The optical device according to claim 9, wherein the transmission mechanism includes a connecting portion that transmits the force to the movable member by engaging with a guide portion provided in the movable member; and the other end of the biasing member engages with a second engaging portion provided in the connecting portion.

11. The optical device according to claim 10, wherein the biasing member is an elastic member that attracts the first and second engaging portions to each other.

12. The optical device according to claim 4, wherein the guide portion includes a curved guide surface when viewed from an optical axis direction.

13. The optical device according to claim 10, wherein a guide surface of the guide portion with which the connecting portion is brought into contact in a state between the inserted state and the retracted state has a shape protruding in a direction opposite to a direction in which the connecting portion is biased by the biasing member when viewed in an optical axis direction.

14. An imaging element comprising:
the optical device according to claim 1; and
an imaging element configured to image an object via the optical device.
